(19) United States
(12) Patent Application Publication
(10) Pub. No.: US 2025/0282067 A1
(43) Pub. Date: Sep. 11, 2025

(54) Safety Device for Safeguarding a Danger Zone of an Automatically Operating Machine, in Particular an Industrial Robot

(71) Applicant: Pilz GmbH & Co. KG, Ostfildern (DE)

(72) Inventors: Fabio PERRONE, Ostfildern (DE); Daniel BAKOVIC, Ostfildern (DE); Fahri DEMIRCI, Ostfildern (DE); Onedin IBROCEVIC, Ostfildern (DE)

(21) Appl. No.: 19/219,253

(22) Filed: May 27, 2025

Related U.S. Application Data
(63) Continuation of application No. PCT/EP23/83735, filed on Nov. 30, 2023.

(30) Foreign Application Priority Data
Nov. 30, 2022 (DE) 10 2022 131 775.7

(51) Int. Cl. B25J 19/06; B25J 9/16; B25J 13/08

(52) U.S. Cl. CPC B25J 19/06; B25J 9/1676; B25J 13/089

(57) ABSTRACT

A safety device for safeguarding a danger zone of a robot having a first body part configured to rotate about a first axis of rotation and having at least one further body part configured to rotate relative to the first body part about a further axis of rotation during robot operation. The safety device includes multiple sensors, each of which is configured to monitor a respective defined spatial sector in a vicinity of the robot and configured to generate a respective sensor signal in response to an object being detected in the respective defined spatial sector. The safety device includes a support structure configured to fix the sensors to the robot so that the sensors rotate together with the first body part about the first axis of rotation. The safety device includes an evaluation and control unit configured to control operation of the robot.

### CROSS-REFERENCE TO RELATED APPLICATIONS

This application is a continuation of International Application No. PCT/EP2023/083735 filed Nov. 30, 2023, which claims priority to DE 10 2022 131 775.7 filed Nov. 30, 2022. The entire disclosures of the above applications are incorporated by reference.

### FIELD

The present invention relates to a safety device for safeguarding a danger zone of an automatically operating machine, in particular for safeguarding the danger zone of a robot having a serial kinematic including a first axis of rotation and further axes of rotation.

### BACKGROUND

For many years, there have been a desire and efforts to safeguard the danger zone resulting from the rapid movements of an industrial robot as simply and flexibly as possible in order to prevent accidents and injuries. In particular, it is desirable to have a safeguard that allows a per-son to remain in the vicinity of the robot and carry out any activities, for example to enable the person and the robot to work together. Such efforts are known as human-robot collaboration. The two-part standard EN ISO 10218 defines requirements for collaborative operation of a robot. For example, predefined contact forces on the person must not be exceeded in the event of contact between the robot and the person. As a result, it is known that the position, force and/or torques and/or the speed at which the robot or parts of the robot's body move must be monitored and, if necessary, limited. The monitoring and limitation must also be guaranteed in the event of an error, i.e. it must be fail-safe, for example if a component fails or in the event of a software error.

In the following, the term “fail-safe” is used to express that a component or arrangement fulfills the requirements of category 3 or the requirements for the so-called performance level PL d according to the standard EN ISO 13849-1 and/or the safety requirement level SIL 3 according to the standard IEC 61508 as well as the machine-specific sector standard EN 62061.

EP 3 909 727 A1 discloses a safety device having a total of six presence sensors, all of which are arranged on a U-shaped holder. The three presence sensors are respectively arranged vertically one on top of each other on a respective one of the two legs of the U-shaped holder. The respective opposing sensors “look” in opposite directions and monitor areas at the side of the robot. The holder with the six presence sensors is arranged on a lever mechanism that is attached between two swivel joints of the robot. The lever mechanism moves in a direction opposite to the movements of the arm parts so that the holder with the presence sensors is always held in a horizontal position and the vertical alignment of the sensors is maintained.

WO 2018/145990 A1 discloses a further safety device for safeguarding a robot. On the one hand, this known device uses a sensor permanently installed in the floor area of the robot, which sensor can be, for example, a safety mat, a laser sensor, a camera or an ultrasonic sensor. The permanently installed sensor is used to monitor the floor area around the robot. In addition, the safety device of WO 2018/145990 A1 comprises a further sensor at the free end of the robot arm in the area of the so-called end effector. The further sensor is arranged vertically above the end effector and monitors an umbrella-shaped, downward-facing sensor field. The additional sensor can be a laser sensor, a camera or an ultrasonic sensor. The ground-level sensor field of the permanently installed sensor can be divided into several concentric sub-circles, with each sub-circle being assigned a different safety level. Different safety levels can be associated with different movement speeds of the robot.

WO 2006/024431 A1 discloses a further safety device for safeguarding a robot. This de-vice comprises eight ultrasonic proximity sensors permanently installed in the floor area of the robot, each of which proximity sensors monitors a defined sector. The monitored sectors are dis-tributed like a fan over approx. 180° around the robot. The safety device also comprises fences or light barriers that prevent lateral access to the robot behind the monitored sectors, as well as a rear-mounted laser scanner that monitors the fenced area on the back of the robot at ground level. A safety controller ensures that the robot switches to a slowed-down mode or is even stopped if a person moves into a sector that is within the range of the robot arm's current position.

In principle, the known safety devices are suitable for achieving safe operation of a robot. However, they partly impair the productivity of the robot because its movement speed is often limited to a slow speed for safety reasons, even if this would not be necessary on closer inspection. In addition, some of the known safety devices require a large number of sensors that monitor static spatial areas around the robot or they are specially developed for a specific type of robot and cannot be used on another robot without expensive adaptation.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Against this background, it is an object of the present invention to provide a safety device, which makes it possible to safeguard a robot or a similar machine in an efficient manner.

It is another object to provide a safety device which enables high productivity of a robot without endangering persons in the vicinity of the robot.

It is yet another object to provide a safety device for a robot, which can be used in a cost-effective manner for a plurality of robot types.

According to one aspect there is provided a safety device for safeguarding a danger zone of a robot having a first body part configured to rotate about a first axis of rotation and having at least one further body part configured to rotate relative to the first body part about a further axis of rotation during robot operation, the first body part having an outer shell, and the safety device comprising a plurality of sensors, each of which is configured to monitor a respective defined spatial sector in a vicinity of the robot and configured to generate a respective sensor signal when an object is detected in the respective defined spatial sector, comprising a support structure configured to fix the plurality of sensors to the robot in such a manner that the plurality of sensors rotate together with the first body part about the first axis of rotation, and comprising an evaluation and control unit configured to control operation of the robot in response to the sensor signals of the plurality of sensors, wherein the support structure has a support base designed to embrace the outer shell of the first body part in a form-fit manner from outside.

According to another aspect, there is provided a safety device for safeguarding a danger zone of an automatically operating machine, the machine comprising a machine body part which has an outer shell and which executes a rotary movement about an axis of rotation during ma-chine operation, the safety device comprising a plurality of sensors, each of which is configured to monitor a respective defined spatial sector in a vicinity of the machine and to generate a respective sensor signal when an object is detected in the respective defined spatial sector, comprising a support structure configured to fix the plurality of sensors to the machine in such a manner that the plurality of sensors rotate together with the machine body part during machine operation, and comprising an evaluation and control unit configured to control the rotary movement of the machine body part in response to the sensor signals of the plurality of sensors, wherein the support structure has a support base designed to embrace an outer shell of the ma-chine body part from outside in a form-fit manner.

The sensors of the new safety device are rigidly connected to the rotating machine body part and therefore change their current “viewing direction” in response to the rotary movement of the machine body part. The spatial sectors rotate together with the machine body part around the axis of rotation and are therefore quasi-stationary in relation to the moving machine body part. However, the monitored spatial sectors move in relation to a fixed point in the vicinity of the ma-chine. This distinguishes the new safety device from concepts that use fixed sensors to monitor static spatial areas. The new safety device makes it possible to get along with a comparatively small number of sensors, which contributes to efficient and cost-effective implementation.

Furthermore, the sensors are mechanically connected to the moving machine body part via a new support structure. The machine is in particular an industrial robot with serial kinematics, such as in particular an articulated arm robot or a SCARA robot, and the moving machine body part is a rotatable arm part of the robot in the preferred exemplary embodiments. The serial kinematics include a first axis of rotation and further axes of rotation or swivel joints, via which the arm parts are connected so that they can rotate or swivel (relative to each other). In preferred exemplary embodiments of the new safety device, the machine body part, whose outer shell is embraced by the support base in a form-fit manner, is the first axis of rotation of the robot, i.e. an axis of rotation that connects the robot to a stationary foundation. Attaching the sup-port structure to or on the first axis of rotation has the advantage that the payload, i.e. the load that the robot can carry and handle, is only slightly reduced by the support structure and the sensors, if at all. In preferred exemplary embodiments, the support base embraces the outer shell of a vertical axis of rotation, i.e. a machine body part that enables the machine to rotate about a vertical axis of rotation.

The outer shell of the machine body part is the outside of a housing or cladding that separates the machine body part from its surroundings. The support base is advantageously matched to the outer shell of the machine body part and placed on the outer shell of the machine body part. The support base “rides” on the machine body part, so to speak, while the machine body part rotates. In preferred exemplary embodiments, the support base is made up of several parts, with the several parts embracing the outer shell of the machine body part like a clamp. The ad-vantage of this implementation is that the support structure with the sensors can be adapted very easily and cost-effectively to a variety of different robot types from different manufacturers and different robot sizes. In preferred exemplary embodiments, it is sufficient to use 3D data of the outer shell, for example CAD data or 3D data captured with a 3D scanner, to construct a support base matched to the outer shell. In preferred exemplary embodiments, the support structure is also made up of several parts and, in addition to the support base, comprises further elements to which sensors are or can be attached. In this case, it is sufficient to construct a matched support base in order to fit the support structure to another robot type or another robot size.

Preferably, the sensors mentioned above are each radar sensors, because radar radiation with electromagnetic waves from the microwave range is very robust against fog, dust, dirt, flying sparks or rain. In preferred exemplary embodiments, the radar sensors work with an operating frequency in the range from 10 GHz to 80 GHz, preferably with an operating frequency in the range between 20 GHz and 30 GHz or with an operating frequency in the range between 60 GHz and 70 GHz. These frequency ranges allow fast and positionally accurate detection of collision objects even when the above-mentioned environmental factors impair a “clear view”. This makes these sensors ideal for harsh industrial environments. Alternatively, the sensors mentioned above could in principle be lidar sensors that work with light from the optical and/or infra-red wavelength range, cameras or ultrasonic sensors. A combination of different sensor principles is also conceivable for the plurality of sensors.

The new sensor arrangement can be used quite universally and cost-effectively on various machines. The co-rotating sensors enable efficient safeguarding and allow high productivity, especially in the case of human-robot collaboration.

In a preferred refinement, the support base forms an interior space which is designed to accommodate the machine body part in a pot-like manner.

In this refinement, the support base defines an interior space which accommodates the outer shell of the machine body part to a certain extent when the support structure is attached to the machine. In preferred exemplary embodiments, the interior space is substantially cylindrical. Furthermore, it is preferred in some exemplary embodiments if the interior space accommodates more than 50% of the outer shell, preferably more than 75% of the outer shell of the moving machine body part. This refinement allows a very stable attachment of the support base to the outer shell of the machine body part. A substantially cylindrical interior space can be used for a variety of robot types and robot sizes and therefore enables cost-effective implementation and adaptation. In order to save material and weight, the pot-like receptacle can have openings or holes in the side walls, i.e. the “pot” can but does not have to be completely closed all around. An interior space that is completely enclosed on the outside is advantageous in some exemplary embodiments in order to prevent chips from workpiece machining or other contaminants from collecting where the support base is attached to the machine body part.

In a further refinement, the support base has a first half-shell and a second half-shell, which together are designed to embrace the outer shell in a clamp-like manner.

In this refinement, the support base is essentially in two parts. In some preferred exemplary embodiments, the half-shells are bolted together. This refinement enables very simple and also stable mounting of the support base on the machine body part.

In a further refinement, the support base is designed to surround the outer shell of the machine body part in two mutually different, non-parallel planes.

Particularly in a robot with serial kinematics, such as an articulated arm robot, the ma-chine body part surrounded by the support base is often followed by a further arm part with an orientation that is transverse and often orthogonal to the main direction of the machine body part or to its axis of rotation. The refinement makes it possible to fix the support base to the machine body part in a particularly stable manner, especially if the non-parallel planes are perpendicular to the axes of rotation of the machine body part and the further arm part.

In a further refinement, the support structure comprises a beam fixed to the support base, wherein at least one sensor from the plurality of sensors is held via the beam at a distance from the support base.

This refinement makes it easy to place one or more sensors at a freely selectable height or at a freely selectable distance from the moving part of the machine body. This refinement therefore makes it easier to optimize the spatial sectors monitored by the sensors. For example, one or more sensors can be positioned very easily in such a way that their field of vision is not or only insignificantly impaired by other machine parts in this refinement.

In some preferred exemplary embodiments, the sensor arrangement comprises a plurality of sensors forming a first sensor group and a second sensor group, wherein the sensors of the first sensor group define a first sensor plane during machine operation, wherein the sensors of the second sensor group define a second sensor plane during machine operation, and wherein the first sensor plane is remote from the second sensor plane. For example, the first sensor plane may lie vertically below the second sensor plane. Such an arrangement of several sensors at separate levels can be implemented very easily and cost-effectively by means of the refinement and enables advantageous all-round safeguarding of the moving machine body part with a small number of sensors. In preferred exemplary embodiments, the first level is close to the floor, i.e. the monitored spatial sectors of the sensors from the first sensor group extend down to the floor. They rest on the floor, so to speak. The sensors of the first sensor group advantageously have a main viewing direction that is essentially perpendicular to the axis of rotation. In contrast, in preferred exemplary embodiments, the main direction of view of the sensors of the second sensor group runs at an angle to the main direction of view of the sensors of the first sensor group, in particular at an angle to the floor. The sensors of the first sensor group can be used to efficiently monitor the spatial area around the moving machine body part, but without the moving machine body part itself. The sensors of the second sensor group, on the other hand, can be used to monitor a spatial area radially in front of the moving machine body part, as it were from diagonally above, without the machine body part obscuring the line of sight of the sensors of the second sensor group.

In a further refinement, at least one sensor from the plurality of sensors is held on the support base.

The refinement enables very simple mounting of the at least one sensor in direct vicinity of the moving machine body part. The moving machine body part can therefore be safeguarded very efficiently.

In some exemplary embodiments, the sensor device has three sensors covering approximately 270° of all-round vision. In particular, the plurality of sensors may include a first sensor that monitors a first defined spatial sector and generates a first sensor signal when an object is detected in the first spatial sector. Furthermore, the plurality of sensors may include a second sensor that monitors a second defined spatial sector and generates a second sensor signal when an object is detected in the second sector of space, and the plurality of sensors may include a third sensor that monitors a third defined spatial sector and generates a third sensor signal, when an object is detected in the third spatial sector, wherein the first spatial sector, the second spatial sector and the third spatial sector are different from each other, wherein the first and second spatial sectors are adjacent to each other during machine operation, and wherein the second and third spatial sectors are adjacent to each other during machine operation. Advantageously, the first spatial sector, the second spatial sector and the third spatial sector are distributed around the axis of rotation during machine operation such that the first spatial sector, the second spatial sec-tor and the third spatial sector follow one another in the current direction of rotation when the machine body part rotates. The afore-mentioned sensors can advantageously form the first sensor group close to the ground and together monitor an azimuthal spatial sector that omits the machine body part such that the field of view of these sensors is free.

Advantageously, the monitored spatial sectors lie next to each other in the plane of rotation of the machine body part and follow each other as the machine body part rotates. The plane of rotation is essentially perpendicular to the axis of rotation, in particular orthogonal to the axis of rotation. This means that the monitored spatial sectors sweep over the same spatial areas one after the other along the current direction of rotation. The respectively trailing or leading spatial sectors allow for high productivity, as a slow creep speed or a safety stop is only triggered if an object to be protected, such as in particular a person or a part of a person's body, is directly in the movement range of the moving machine body part. The movement path of the machine body part can be divided into very critical and less critical spatial areas in a very simple and cost-effective manner due to the arrangement of the moving spatial sectors. The safety distances at which a safety function is triggered can be reduced compared to known safety devices. Unnecessary creeping movements at slow speed can be reduced to a minimum. At the same time, the rotating spatial sectors mean that a safety stop or creep speed can be triggered at any time if a person is located directly in front of the machine body part in the current direction of rotation.

In a preferred exemplary embodiment, the sensors each monitor a pie-shaped spatial sector that extends from the respective sensor over an azimuthal opening angle that is greater than an opening angle in elevation. The azimuthal opening angle is preferably in the plane of rotation of the respective sensor. The opening angle in elevation is preferably defined parallel to the axis of rotation. In some advantageous exemplary embodiments, the azimuthal opening angle lies in a range between 20° and 120° and the opening angle in elevation lies in a range between 10° and 30°. The adjacent spatial sectors can overlap at their respective boundaries. Preferably, the angular range in which the adjacent spatial sectors overlap is small compared to the respective opening angle. In preferred exemplary embodiments, the azimuthal overlap angle of two ad-jacent spatial sectors is at most 20% of the respective azimuthal opening angle, preferably at most 10%. Accordingly, each of the three sensors mentioned above monitors more than half of the spatial sector exclusively assigned to it. Preferably, each of the three sensors mentioned above monitors more than 75% of the spatial sector assigned to it exclusively.

The refinement makes an advantageous contribution to maximizing the productivity of the machine by reducing or even avoiding unnecessary false shutdowns and creep speeds of the machine and only triggering a safety function in the form of a shutdown or creep speed by the new safety device in necessary cases.

In a further refinement, the support structure has a friction-enhancing intermediate element which is intended to be placed between the support base and the outer shell.

The intermediate element can be an insert made of an elastic material, such as rubber, sponge rubber, or a fabric-like material, such as a felt material. The intermediate element can be arranged over a large area in the interior space of the support base and, in particular, cover more than 50% of the contact surface between the outer shell of the machine body part and the sup-port base. Alternatively, the intermediate element may comprise a plurality of intermediate elements arranged at several separate contact points. In some exemplary embodiments, the inter-mediate element may be placed as a loose insert around the machine body part before the sup-port base is mounted to the machine body part. In other exemplary embodiments, the intermediate element can be attached to the contact surfaces of the support base before assembly, for example by means of an adhesive connection. A friction-enhancing intermediate element in-creases the contact friction between the outer shell of the machine body part and the support base compared to mounting without the intermediate element. The refinement makes an advantageous contribution to achieving a stable, torsion-resistant connection between the support base and the outer shell of the machine body part by achieving an (increased) frictional connection in addition to a form-fit. In preferred exemplary embodiments, the outer shell of the machine body part is “suction-fitted” into the support base with the aid of the intermediate element.

In a further refinement, the support base is configured to be attached to the machine body part in a non-destructive, detachable manner.

This refinement is advantageous because it facilitates maintenance and, if necessary, re-pair of the machine in the area of the rotary axis. Furthermore, the machine can be converted very easily if a new safety device is required, for example for a new use of the machine.

In a further refinement, the evaluation and control unit has a fail-safe first evaluation and control unit and a non-fail-safe second control unit, wherein the second control unit controls the movement of the machine body part in response to an operating program and in response to a binary enable signal from the first evaluation and control unit, and wherein the first evaluation and control unit generates the binary enable signal in response to the plurality of sensors.

As mentioned above, “fail-safe” in this case means that the first evaluation and control unit fulfills the requirements of category 3 or the requirements for the so-called performance level PL d according to the standard EN ISO 13849-1 and/or the safety requirement level SIL 3 according to the standard IEC 61508 or the machine-specific sector standard EN 62061. In contrast, the second control unit does not meet these requirements. It is therefore a so-called standard control unit, which essentially controls the desired operating sequence of the machine in accordance with an operating program. The refinement enables safe and productive operation of the machine in a cost-effective manner. In particular, with this refinement, a machine that was previously safeguarded in a different manner can be retrofitted with the new safety device and therefore achieve increased productivity without extensive changes to the desired operating sequence.

Preferably, the first evaluation and control unit generates two mutually redundant binary enable signals, each of which can have a high signal level (on state) or a low signal level (off state). The high signal level indicates that, in particular, the first spatial sector leading in the direction of rotation is free. The second control unit can then rotate the machine body part at a high rotational speed if this is intended in the desired operating sequence. The high signal level is therefore a fail-safe enable signal for the high rotational speed. The low signal level, on the other hand, indicates that the enable signal is no longer present, which means that the second control unit moves the machine body part at a limited, slow rotational speed at best. Preferably, the first evaluation and control unit generates the two redundant binary enable signals each with a test pulse, i.e. defined pulses from the high signal level to the low signal level. The test pulses make it possible to detect a stuck-at-high error in the output circuit of the first evaluation and control unit. Preferably, the test pulses of the two mutually redundant binary enable signals are out of phase with each other, which enables advantageous cross-circuit detection. The refinement enables a simple, hard-wired handshake between the first evaluation and control unit and the non-fail-safe second control unit.

In a further refinement, the evaluation and control unit is configured to limit the rotational speed of the machine body part around the axis of rotation in a fail-safe manner in response to sensor signals from the sensors.

In this refinement, the machine body part is moved at a reduced rotational speed com-pared to trouble-free operation. The so-called creep speed of the machine body part, when an object is detected in the respective spatial sector leading in the direction of rotation, makes a beneficial contribution to maintaining the productivity of the machine, albeit with a slower movement due to the risk of collision in the spatial sector leading in the direction of rotation.

In a further refinement, at least one sensor of the plurality of sensors has a first and a separate second detection area within the associated spatial sector, wherein the first detection area is closer to said sensor than the second detection area, wherein said sensor generates separate sensor signals for each of the two detection areas, and wherein the evaluation and control unit is configured to control the rotation of the machine body part in dependence on the separate sensor signals.

In this refinement, the spatial sector of the at least one sensor is divided into two different distance ranges. Advantageously, all sensors from the plurality of sensors have such a first and separate second detection area within the respective monitored spatial sectors. The refinement makes it possible in a simple way for the evaluation and control unit to trigger different reactions depending on the distance of an object in the monitored spatial sector. Advantageously, the evaluation and control unit can generate an optical and/or acoustic warning signal at a greater distance in order to prevent a person from entering the working area of the machine any further. On the other hand, the evaluation and control unit can immediately reduce the speed of movement of the machine body part when an object is detected at a shorter distance and/or stop the movement of the machine body part. Alternatively, the evaluation and control unit can also re-duce the rotational speed of the machine body part as soon as the warning signal is generated. The refinement helps to achieve high productivity together with safe operation of the machine.

It is understood that the above-mentioned features and those yet to be explained below can be used not only in the combination indicated in each case, but also in other combinations or on their own, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 an exemplary embodiment of the new safety device on an articulated robot.

FIG. 2 the safety device of FIG. 1, wherein three monitored room sectors are shown schematically.

FIG. 3 the safety device from FIG. 1, wherein three further monitored room sectors are schematically shown.

FIG. 4 the articulated arm robot of FIG. 1 with a half-shell of a support base of the safety device of FIG. 1.

FIG. 5 the support base of the safety device of FIG. 1 with two half-shells.

In the drawings, reference numbers may be reused to identify similar and/or identical elements.

### DETAILED DESCRIPTION

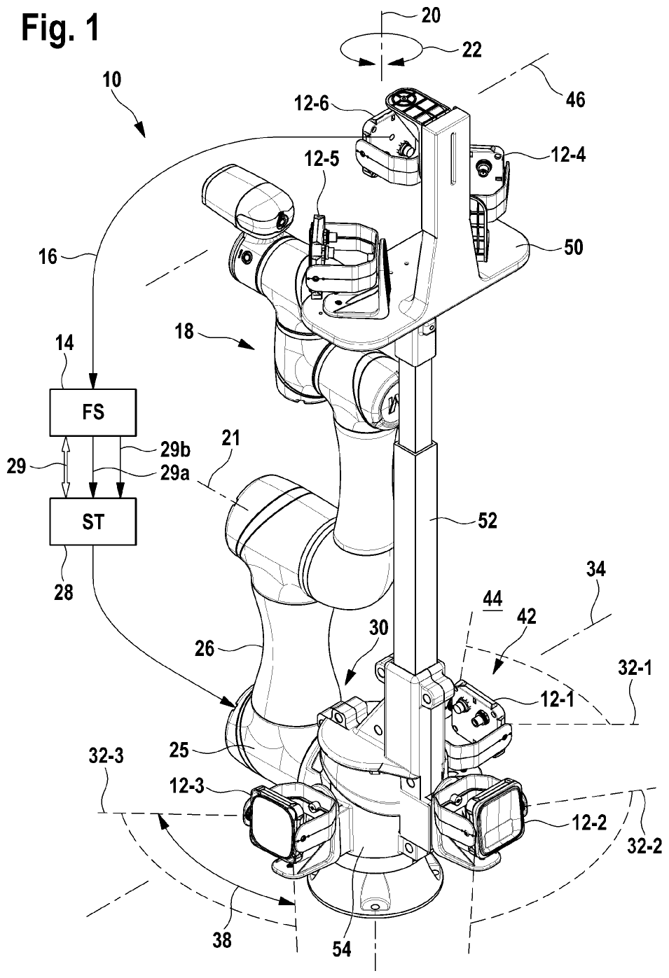

In FIG. 1, an exemplary embodiment of the new safety device is designated by the reference numeral 10 in its entirety. In this exemplary embodiment, the safety device 10 comprises 6 radar sensors 12-1, 12-2, 12-3, 12-4, 12-5 and 12-6, which are hereinafter collectively referred to by the reference numeral 12, and a fail-safe evaluation and control unit 14, which in this case is connected to the radar sensors 12 via a serial bus connection 16 (only schematically indicated here). In preferred exemplary embodiments, the serial bus connection 16 is based on a CAN bus protocol, which enables very efficient data transmission between the sensors connected in series and the evaluation and control unit 14. In some exemplary embodiments, the evaluation and control unit 14 comprises a fail-safe controller called PNOZmulti 2, which is commercially available from the Pilz GmbH & Co KG based in 73760 Ostfildern, Germany.

The sensors 12 are arranged in this case on an articulated arm robot 18 and can accordingly rotate together with the robot 18 about an axis of rotation 20 of the robot 18. In this case, the axis of rotation 20 is the first of several axes of rotation of the robot 18 and it runs here perpendicular to the floor or foundation on which the robot 18 is placed with its base.

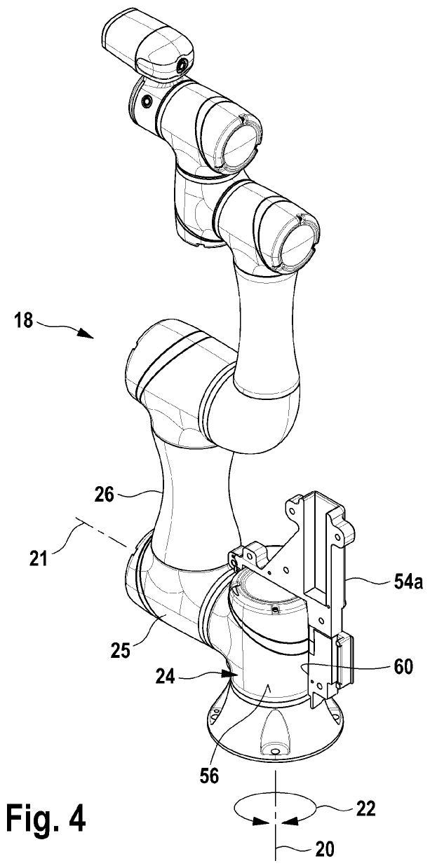

In some exemplary embodiments, the robot 18 can perform pick-and-place tasks, whereby it rotates in alternating directions around the axis of rotation 20. A respective current direction of rotation is indicated at reference numeral 22. As is known to those skilled in the art, the robot 18 has several arm parts which are rotatably connected to one another via swivel joints. Some of these arm parts are designated here by the reference numerals 24, 25, 26 (see also FIG. 4). The rotations of the arm parts 24, 25, 26 relative to one another and the rotation of the robot 18 about the axis of rotation 20 are controlled here by a non-fail-safe control unit 28. The control unit 28 can be a conventional robot controller, as typically offered by the manufacturer of the robot 18 and supplied together with the robot. The control unit 28 controls the desired operational sequence of the robot 18 in a manner known per se according to an operational pro-gram, which is typically loaded into the control unit 28. In some preferred exemplary embodiments, the evaluation and control unit 14 and the operational control unit 28 of the robot may communicate with each other via a bidirectional connection 29. In some exemplary embodiments, the connection 29 may include a fail-safe bus connection, for example based on a fail-safe Ethernet protocol. In preferred exemplary embodiments, the connection 29 includes two or more redundant, binary enable signals 29a, 29b, so-called OSSD signals, such as those provided by the applicant's fail-safe small controller PNOZmulti 2.

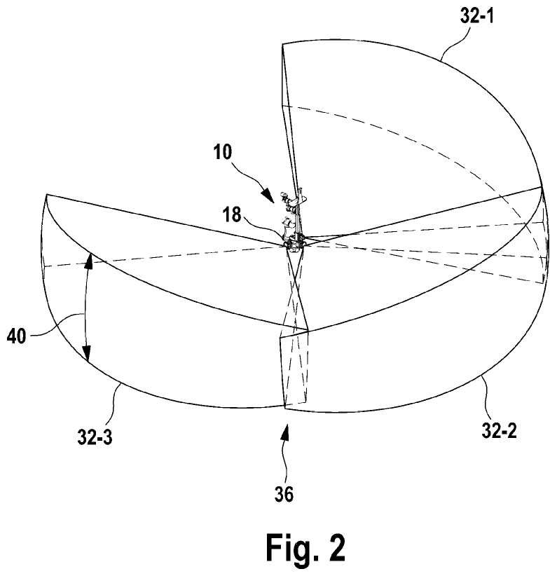

Depending on the operating situation, the movable arm parts form a contour 30 that leads in the current direction of rotation 22, which contour can exert a high contact force on a person or an object (not shown here) in the event of a collision with the person or the object in the rotation range of the robot 18. To prevent this, the sensors 12 each monitor a defined, assigned spatial sector 32. In FIG. 1, a first spatial sector 32-1, a second spatial sector 32-2 and a third spatial sector 32-3 are each indicated by dashed lines. For example, the first sensor 12-1 monitors the first spatial sector 32-1, the second sensor 12-2 monitors the second spatial sector 32-2 and the third sensor 12-3 monitors the third spatial sector 32-3. The three spatial sectors 32-1, 32-2 and 32-3 are adjacent to one other and the sensors 12-1, 12-2 and 12-3 define a plane 34, which in this case is close to the ground and largely parallel to the ground. FIG. 2 shows the three spatial sectors 32-1, 32-2 and 32-3 in a perspective view.

As can be seen from FIG. 2, the monitored spatial sectors 32-1, 32-2 and 32-3 overlap from a certain distance in the adjoining areas, so that the three sensors 12-1, 12-2 and 12-3 here together cover a contiguous rotation angle range 36, which surrounds the robot 18 here on three sides. In the illustrated exemplary embodiment, the spatial sectors 32-1, 32-2 and 32-3 together cover a rotation angle range 36 which is approximately 270°. In this case, each of the three sensors 12-1, 12-2 and 12-3 monitors a spatial sector 32-1, 32-2 and 32-3 assigned to it, which respective sector covers approximately one third of the rotation angle range 36. The jointly monitored rotation angle range 36 extends in the azimuthal direction and does not comprise the robot 18. Accordingly, the arm parts 25, 26, more generally the robot 18, do not generate any radar reflections that could be detected by the sensors 12-1, 12-2 and 12-3 in this exemplary embodiment.

The division of the azimuthal spatial sector 36 into three largely equally sized monitored spatial sectors 32-1, 32-2, 32-3 has proven to be very advantageous in some exemplary embodiments in order to monitor the rotation angle range of the robot 18 with a small number of sensors in such a manner that the robot 18 can be operated with a high level of productivity. Advantageously, the fail-safe evaluation and control unit 14 generates the above-mentioned enable signals if the spatial sector immediately ahead in the current direction of rotation is “free”, i.e. the assigned sensor does not detect any potential collision object in the spatial sector it is monitoring. Thus, for example, if the robot 18 is to rotate clockwise in a defined operating situation, the evaluation and control unit 14 generates the above-mentioned enable signal if the spatial sector 32-1 is free, i.e. if the first sensor 12-1 does not detect a collision object in the spatial sector 32-1. Conversely, the evaluation and control unit 14 generates the above-mentioned enable signal if the robot 18 is to rotate counterclockwise in another operating situation and the spatial sector 32-3 is free, i.e. if the third sensor 12-3 does not detect a collision object in the spatial sector 32-3. Irrespective of this exemplary embodiment, in further exemplary embodiments in which the ma-chine body part 24, 26 passes through a rotation angle range of less than or equal to 300° during intended operation, it is advantageous if the safety device 10 monitors the said rotation angle range with three, four or at most five spatial sectors which together cover the entire rotation angle range.

As can also be seen in FIG. 2, the monitored spatial sectors 32-1, 32-2, 32-3 each have a shape that resembles a piece of a pie or cake in this case, i.e. corresponds to a sector of a circle in a plan view, but is limited in elevation. In other words, the azimuthal opening angle 38, which is indicated in FIG. 1 for the spatial sector 32-3 at reference numeral 38, is greater than the opening angle 40 in elevation.

In preferred exemplary embodiments, some or even all of the sensors from the plurality of sensors 12-1 to 12-6 have a first detection area 42 and a separate second detection area 44 within the respective monitored spatial sector (indicated in FIG. 1 using the example of the first sensor 12-1). The first detection area 42 is located closer to the respective sensor than the second detection area 44. The respective sensor generates separate sensor signals for each of the two detection areas 42, 44, and the evaluation and control unit 14, 28 is configured to control the rotation of the machine body part 24, 26 in response to the separate sensor signals. The separate detection areas 42, 44 make it possible to take into account a current distance of the potential collision object to the robot 18 when controlling the rotational movement. For example, if an object is detected in the second, more distant detection area 44, only a visual and/or acoustic warning signal can be triggered by the evaluation and control unit 14, 28 and only an object detection in the first detection area 42 triggers a reduction in the current rotational speed or even an emergency stop. In further exemplary embodiments, the evaluation and control unit 14, 28 can be configured to limit the current rotational speed of the machine body part in the event of an object detection in the more distant detection area 44 or to reduce it to creep speed, while an object detection in the closer detection area 42 always triggers an emergency stop. In principle, the monitored spatial sectors can also have more than two separate detection areas staggered in distance, whereby the evaluation and control unit 14, 28 is configured to control the rotary movement of the machine body part in response to the azimuthal position of the object (detected by means of the respective spatial sector or sensor signal) and by means of the respective distance (detected by means of the respective detection area).

In the exemplary embodiment shown in FIG. 1, the safety device 10 has two sensor groups with a total of 6 sensors. The sensors 12-1, 12-2 and 12-3 form a first sensor group and define a level 34 close to the ground. The sensors 12-4, 12-5 and 12-6 are arranged on a plat-form 50 above the sensors 12-1, 12-2 and 12-3 and form a second sensor group. The platform 50 is held on a support base 54 via a beam 52. The sensors 12-4, 12-5 and 12-6 define a plane 46 in this case, which plane lies vertically above the plane 34. In this exemplary embodiment, sensor 12-6 is arranged even slightly above plane 46.

In the exemplary embodiment shown here, the beam 52 is a telescopic beam with a beam length that can be variably adjusted. This makes it possible to adjust the distance of the platform 50 from the support base 54. Advantageously, the distance between the sensor level 34 and the sensor level 46 can thus be adjusted in response to the height of the robot 18 so that the sensors 12-4, 12-5 and 12-6 have a largely unobstructed field of view past the robot 18 and its arm parts.

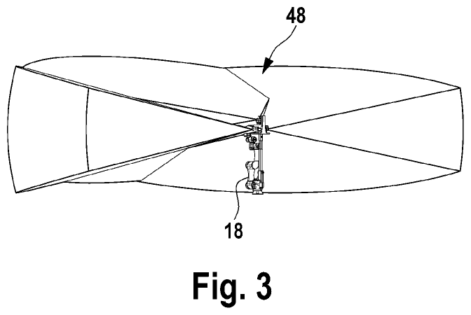

As can be seen from FIGS. 1 and 3, the sensors 12-4, 12-5, 12-6 of the second sensor group jointly monitor a further azimuthal spatial sector 48 which, from the viewpoint of the sensors 12-4, 12-5, 12-6, extends behind the robot 18 or its arm parts. The spatial sectors monitored by the sensors 12-4, 12-5, 12-6 therefore cover in particular the gap left by the azimuthal spatial sector 36 as shown in FIG. 2

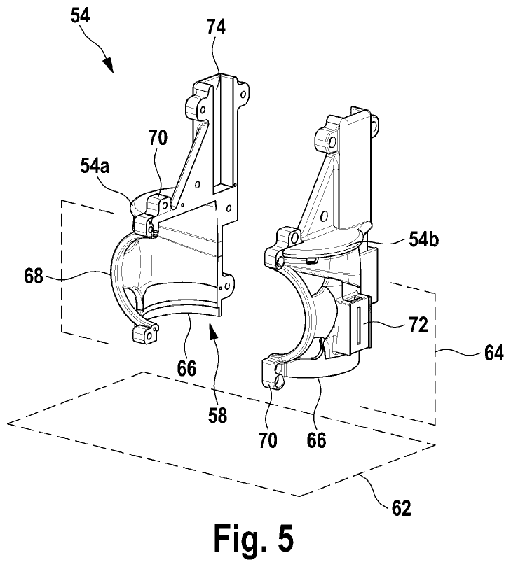

FIG. 4 shows the robot 18 without the safety device 10, but with a half-shell 54a of the support base 54 on the outer shell 56 of the machine body part 24. Otherwise, the same reference numbers designate the same elements as before. FIG. 5 shows the half-shell 54a and a second half-shell 54b, which can be placed as separate parts onto the outer shell 56 of the ma-chine body part 24 from the outside in order to mount the support base 54 on the machine body part 24. As can be seen from FIGS. 4 and 5, the half-shells 54a, 54b in this exemplary embodiment together form an inner space 58 in which the outer shell 56 of the machine body part 24 can be almost completely accommodated

In some preferred exemplary embodiments, a friction-enhancing, in particular rubber-like intermediate element 60 can be arranged in the inner space 58 of the support base 54, and it can “pad” the inner space 58 to a certain extent. In some exemplary embodiments, the inner space 58 is essentially complementary to the outer shell 56 of the machine body part 24 such that the outer shell 56 is received in the inner space 58 in a form-fitting and precisely fitting manner. The optional intermediate element 60 can advantageously compensate for small deviations between the actual shape of the inner space 58 and the actual shape of the outer shell 56 and contribute to a particularly torsion-resistant and stable connection

As can be seen in particular in FIG. 5, the support base 54 embraces the outer shell 56 of the machine body part 24 in this exemplary embodiment in two different planes 62, 64. Each of the two half-shells 54a, 54b has a substantially semicircular edge 66, 68 in this case. The semi-circular edges 66 of the half-shells 54a, 54b lie in a plane 62 which is substantially perpendicular to the axis of rotation 20 of the machine body part 24. In contrast, the semicircular edges 68 of the half-shells 54a, 54b lie in a plane 64 which is substantially parallel to the axis of rotation 20 of the machine body part 24. In the exemplary embodiment shown here, the half-shells 54a, 54b each have flange-like projections 70, which make it possible to screw the two half-shells 54a, 54b together after the half-shells 54a, 54b have been placed onto the outer shell 56 of the ma-chine body part 24 from the outside.

At reference numeral 72 in FIG. 5, a mounting surface is indicated to which one of the sensors 12 can be attached directly to the support base 54 in order to rotate together with the machine body part 24 during machine operation. At reference numeral 74, a further interior space formed by the half shells 54a, 54b is indicated, into which the beam 52 can be inserted.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A safety device for safeguarding a danger zone of a robot having a first body part configured to rotate about a first axis of rotation and having at least one further body part configured to rotate relative to the first body part about a further axis of rotation during robot operation, and the first body part having an outer shell, the safety device comprising:
a plurality of sensors, each of which is configured to monitor a respective defined spatial sector in a vicinity of the robot and configured to generate a respective sensor signal in response to an object being detected in the respective defined spatial sector;
a support structure configured to fix the plurality of sensors to the robot so that the plurality of sensors rotate together with the first body part about the first axis of rotation; and
an evaluation and control unit configured to control operation of the robot in response to the sensor signals of the plurality of sensors,
wherein the support structure has a support base configured to embrace the outer shell of the first body part in a form-fit manner from outside.

2. The safety device of claim 1 wherein the support base forms an interior space configured to accommodate the first body part in a pot-like manner.

3. The safety device of claim 1 wherein:
the support base includes a first half-shell and a second half-shell configured to be attached to the first half-shell, and
the first and second half-shells are configured to jointly embrace the outer shell in a clamp-like manner.

4. The safety device of claim 1 wherein the support base is designed to embrace the outer shell along two different, non-parallel planes.

5. The safety device of claim 1 wherein:
the support structure includes a beam fixed to the support base, and
at least one sensor of the plurality of sensors is held at a distance from the support base via the beam.

6. The safety device of claim 1 wherein at least one sensor of the plurality of sensors is held on the support base.

7. The safety device of claim 1 wherein the support structure includes a friction-enhancing intermediate element configured to be placed between the support base and the outer shell.

8. The safety device of claim 1 wherein the support base is configured to be attached to the first body part in a non-destructive, detachable manner.

9. The safety device of claim 1 wherein:
the evaluation and control unit includes a fail-safe first evaluation and control part and a non-fail-safe second control part,
the second control part is configured to control movement of the first body part in response to an operating program and in response to a binary enable signal from the first evaluation and control part, and
the first evaluation and control part generates the binary enable signal in response to the plurality of sensors.

10. A safety device for safeguarding a danger zone of an automatically operating machine, the machine including a machine body part that has an outer shell and that executes a rotary movement about an axis of rotation during machine operation, the safety device comprising:
a plurality of sensors, each of which is configured to monitor a respective defined spatial sector in a vicinity of the machine and to generate a respective sensor signal in response to an object being detected in the respective defined spatial sector;
a support structure configured to fix the plurality of sensors to the machine so that the plurality of sensors rotate together with the machine body part during machine operation; and
an evaluation and control unit configured to control the rotary movement of the machine body part in response to the sensor signals of the plurality of sensors,
wherein the support structure has a support base configured to embrace an outer shell of the machine body part from outside in a form-fit manner.

11. The safety device of claim 10 wherein the support base forms an interior space configured to accommodate the machine body part in a pot-like manner.

12. The safety device of claim 10 wherein the support base includes a first half-shell and a second half-shell, which together are configured to embrace the outer shell in a clamp-like manner.

13. The safety device of claim 10 wherein the support base is configured to embrace the outer shell of the machine body part along two different, non-parallel planes.

14. The safety device of claim 10 wherein:
the support structure includes a beam fixed to the support base, and
at least one sensor of the plurality of sensors is held at a distance from the support base via the beam.

15. The safety device of claim 10 wherein at least one sensor of the plurality of sensors is held on the support base.

16. The safety device of claim 10 wherein the support structure includes a friction-enhancing intermediate element configured to be placed between the support base and the outer shell.

17. The safety device of claim 10 wherein the support base is configured to be attached to the machine body part in a non-destructive, detachable manner.

18. The safety device of claim 10 wherein:
the evaluation and control unit includes a fail-safe first evaluation and control unit and a non-fail-safe second control unit,
the second control unit is configured to control the rotary movement of the machine body part in response to an operating program and in response to a binary enable signal from the first evaluation and control unit, and
the first evaluation and control unit is configured to generate the binary enable signal in response to the plurality of sensors.

19. An industrial robot comprising:
a first body part configured to rotate about a first axis of rotation and having at least one further body part configured to rotate relative to the first body part about a further axis of rotation during robot operation, the first body part having an outer shell;
a plurality of sensors, each of which is configured to monitor a respective defined spatial sector in a vicinity of the robot and configured to generate a respective sensor signal in response to an object being detected in the respective defined spatial sector;
a support structure configured to fix the plurality of sensors to the first body part so that the plurality of sensors rotate together with the first body part about the first axis of rotation; and
an evaluation and control unit configured to control operation of the robot in response to the sensor signals of the plurality of sensors,
wherein the support structure has a support base configured to embrace the outer shell from outside in a form-fit manner.

20. The robot of claim 19 wherein the first body part has a stationary base secured to a shop floor.
